(19) United States
(12) Patent Application Publication
(10) Pub. No.: US 2025/0277904 A1
(43) Pub. Date: Sep. 4, 2025

(54) A MILLI METER (MM) WAVE IMAGING SYSTEM FOR NON-DESTRUCTIVE TESTING AND DEPLOYING METHODS THEREOF

(71) Applicant: Wavescan Technologies PTE.LTD, Singapore (SG)

(72) Inventors: Kush Agarwal, Singapore (SG); Karthik Thothathri, Singapore (SG)

(21) Appl. No.: 18/858,772

(22) PCT Filed: Apr. 28, 2022
(86) PCT No.: PCT/SG2022/050255

§ 371 Date: Oct. 22, 2024

(51) Int. Cl. G01S 13/90; G01N 22/02

(52) U.S. Cl. CPC G01S 13/9004; G01N 22/02

(57) ABSTRACT

The invention is directed to a mm Wave image scanning system comprising; a RF subsystem configured with multiple transceiver channels for transmitting and receiving electromagnetic waves in mmWave spectrum, a signal processing subsystem for producing high resolution 2D and 3D holographic images based on backscattered wideband data, and a software subsystem configured for predictive analysis. The system further comprises a localisation subsystem resided either in the system or in the automated platform for inspection and an interface subsystem configured for interfacing various subsystems over various wired and wireless interfaces. The image scanning system provides high resolution images to identify the structural defects of assets with a swift process. The invention also related to a method for obtaining images of an area under testing using the system.

### FIELD OF THE INVENTION

The present invention relates generally to a system and associated methods for non-destructive testing (NDT) applications, and particularly to a Millimeter wave (mmWave) image scanning system and associated methods for implementation of a mm wave-based imaging technology (both hardware & software) for non-destructive testing applications.

### BACKGROUND OF THE INVENTION

Periodic non-destructive testing (NDT) of assets is crucial to ensure the structural health of the assets under inspection. The non-destructive testing sector is an age-old sector with a number of technologies addressing the inspection of various assets. The assets include, but are not limited to, facades in high-rise buildings, structural pillars and beams of buildings, floors and ceilings of buildings, indoor facilities with mechanical electrical and plumbing (MEP) fittings, oil and gas pipelines, shipping vessels, aircraft inspection, etc. The various technologies that are currently being used, are X-ray computed tomography (XCT) scanning, Radiography, Phased array ultrasound technique (PAUT), Pulsed eddy current (PEC) and Ground penetration radar (GPR).

Current practices of NDT involve the use of sensors that employ a variety of detection technologies as listed above. All the aforementioned technologies have their limitations as outlined below:
XCT scanning and Radiography—Bulky form factor, safety concerns since it belongs to the category of ionizing radiation and high power equipment;
PAUT—Requires a couplant, and cannot operate with a stand-off distance;
PEC—Unable to detect anomalies in multi-layered composites (carbon or glass fibre). It is also an averaging technique used as a screening tool and not a diagnostics tool;
GPR—Has a bulky form factor, low resolution due to low operating frequencies (low-GHz).

In view of the foregoing limitations, there exists a need to provide a system and method for inspection and testing of various asset structures. In particular, an efficient inspection system to speed up the overall imaging process is needed, without compromising on the image resolution. It is also required to provide a light weight, low power & portable system for non-contact, automated and high-resolution see-through scanning applications.

### SUMMARY OF THE INVENTION

This invention describes a mmWave based holographic imaging technology for non-destructive testing (NDT) applications.

The invention overcomes the limited detection capabilities and reduce the time consumed for inspection using scanners in current practice by achieving non-contact, automated and high-resolution scanning applications with AI models for defect detection and predictive analysis. The invention also focuses on the safe, portable & light weight sensors integrable on automation platform.

Accordingly, one aspect of the invention relates to a mmWave image scanning system comprising; a RF subsystem configured with multiple transceiver channels for transmitting and receiving electromagnetic waves in mmWave spectrum, a signal processing subsystem for producing high resolution holographic images, especially 2D and 3D images, based on backscattered wideband data, and a software subsystem for 3D/2D visualisation and analysis which may be configured with machine learning and AI models for automated and predictive analysis.

In one embodiment, the RF subsystem comprises a high-performance mmWave front-end with an integrated processor and a hardware accelerator.

In one embodiment, the transceiver channel is an integrated single-chip frequency modulated continuous wave (FMCW) radar sensor. The transceiver channel is used to denote the antenna front-end and the RF subsystem.

In one embodiment, the integrated single-chip provides 12 transceiver channels.

The invention is primarily with regards to the system comprising a NXM channel RF front-end, the antenna configuration, associated signal processing techniques including specialized CZT based focusing and phase analysis techniques, deployment mechanisms, data visualization and data interpretation schemes. Here, N is the number of transmitters and M is the number of receivers and have a maximum value of 100. In one embodiment, the number of channels can be NXM channels. In one embodiment, the system comprises a 48-channel RF front-end.

In one embodiment, the RF system comprises with four transceiver ICs (Integrated Circuits) with 48 channels in a particular configuration in space such that they are integrated to work together.

In one embodiment, the signal processing subsystem configured to acquire the coordinate information from the localization subsystem residing in modality of deployment of the scanner.

In one embodiment, the signal processing subsystem employs a multiple input multiple output synthetic aperture radar (MIMO SAR) technique to exploit the availability of 24 channels in the scanner system.

In one embodiment, the signal processing subsystem employs a multiple input multiple output synthetic aperture radar (MIMO SAR) technique to exploit the availability of 48 channels in the scanner system.

In one embodiment, the signal processing subsystem employs a single input single output (SISO) technique that utilizes at least one transmit antenna element and at least one receive antenna element. The signal processing subsystem does not employ a SISO configuration. However, the RF subsystem can be realized in SISO configuration. As pointed out in the signal processing subsystem such a SISO configuration has disadvantages such as lower scanning speed.

In one embodiment, each antenna element operates in a frequency range of 3 GHz to 300 GHz.

In one embodiment, each antenna element operates in a frequency range of 60 GHz to 81 GHz.

In one embodiment, the signal processing subsystem employs a Digital beamforming (DBF)+SAR technique with 24 channels in the scanner system.

In one embodiment, the signal processing subsystem employs a digital beamforming (DBF)+SAR technique with 48 channels in the scanner system.

In one embodiment, the signal processing subsystem employs a Chirp-Z-Transform (CZT) based mechanism to focus for 3D Imaging.

In one embodiment, raw data obtained from all the channels are in a frequency range between 60 GHz to 81 GHz for the signal processing subsystem.

In one embodiment, the signal processing subsystem employs a phase analysis technique for accurate quantification in range direction.

In one embodiment, the system further comprises a localisation subsystem resided either in the system or in the automated platform for inspection.

In one embodiment, the system is modular namely handheld, drone mounted, crawler mounted, robotic arm mounted, pipe mounted.

In one embodiment, the system further comprises an interface subsystem configured for interfacing various subsystems over various wired and wireless interfaces.

In one embodiment, the software subsystem configured for powerful data visualization, mapping and report generation with AI models running for predictive analysis.

In one embodiment, a method for obtaining an image of an area under testing using the system disclosed herein, the method comprising the steps of: combining data from RF subsystem and a localisation subsystem by the signal processing subsystem to perform 3D image reconstruction algorithms; routing the reconstructed 3D image to a software subsystem to visualise the image of area under testing and perform analysis which can be manual or automated using AI models.

In an embodiment, a method of identifying defects in various kinds of assets including infrastructure, oil & gas pipelines, aircraft parts, shipping vessels, storage tanks, and power plants by deploying the mmWave image scanning system disclosed herein.

In an embodiment, a computer readable storage medium having stored thereon, computer readable instructions, when processed by a processor, cause a system to execute the method as described above.

### BRIEF DESCRIPTION OF THE DRA WINGS

The above and other objects, features and other advantages of the present invention will be more clearly understood from the following detailed description taken in conjugation with the accompanying drawings. For the purpose of illustrating the present disclosure, exemplary constructions of the disclosure are shown in the Figures. However, the disclosure is not limited to the specific methods and instrumentalities disclosed herein.

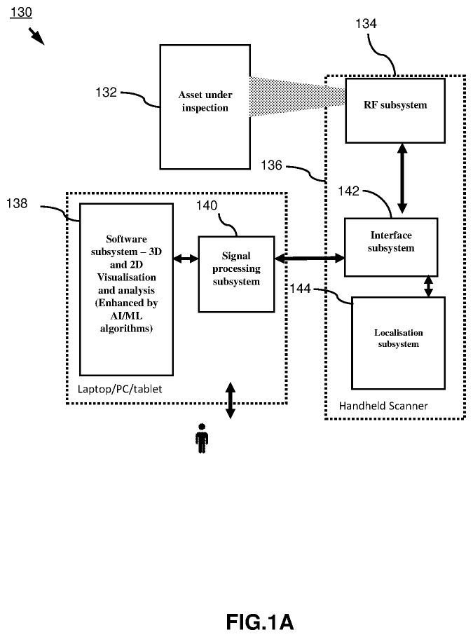

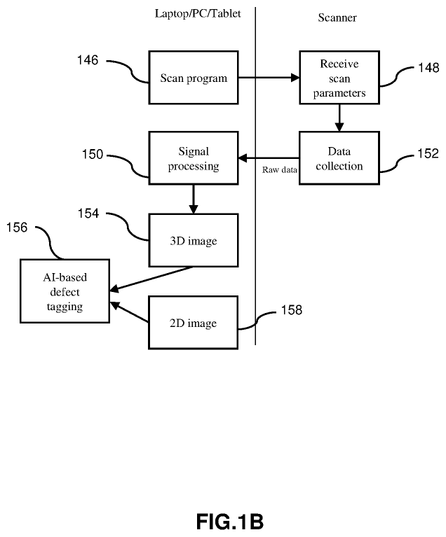

FIG. 1A illustrates a mmWave imaging system having subsystems in the context of a handheld use without an automation platform, in accordance with various embodiments of the present invention; FIG. 1B illustrates a process flow and exchange of information among a personal computer (PC) and a scanner, in accordance with various embodiments of the present invention;

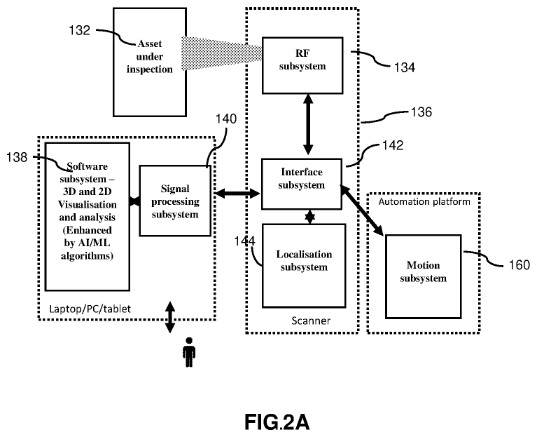

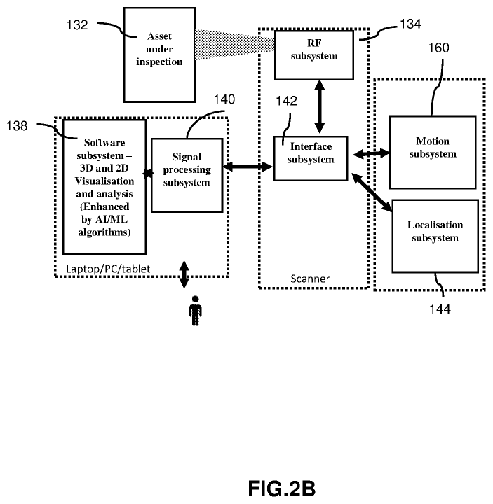

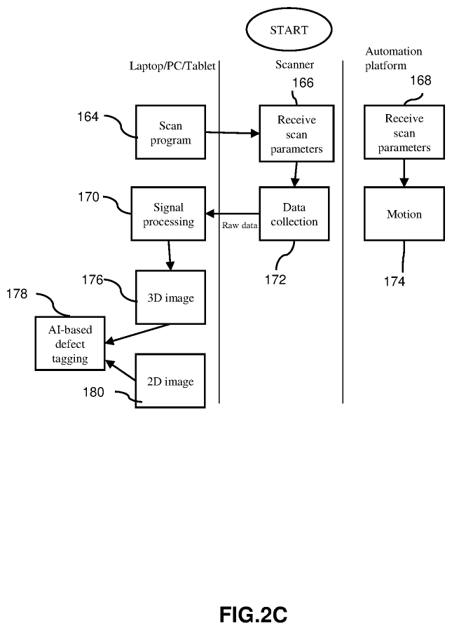

FIG. 2A illustrates a mmWave imaging system having subsystems with an automation platform, where the localisation subsystem is situated in the scanner; FIG. 2B illustrates a mmWave imaging system having subsystems with an automation platform where the localisation subsystem is within the automation platform; and FIG. 2C illustrates a process flow and exchange of information among a PC, a scanner and the automation platform, in accordance with various embodiments of the present invention;

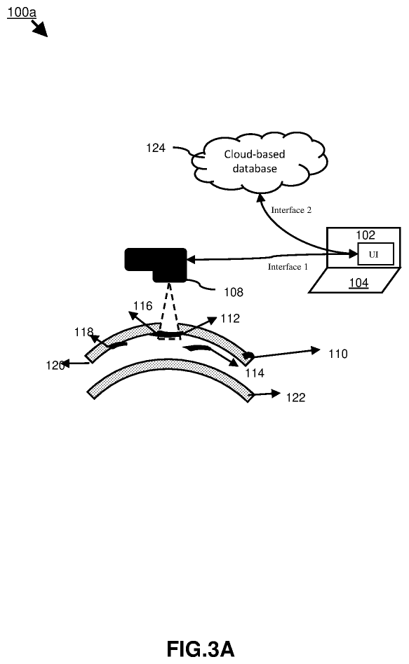

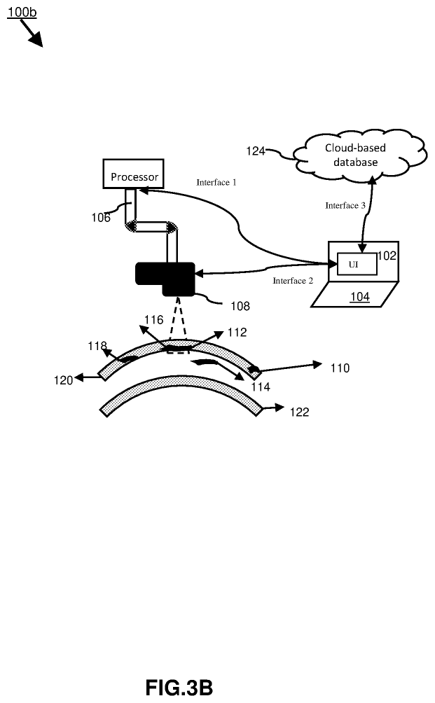

FIG. 3A illustrates a handheld scanner scanning an asset (such as an oil & gas pipeline) and interfaces between a scanner, a computer and a cloud-based database, in accordance with various embodiments of the present invention; FIG. 3B illustrates the scanner mounted on a robotic arm and scanning an asset (such as an oil & gas pipeline) and interfaces between the scanner, computer, robotic arm and cloud-based database in accordance with various embodiments of the present invention;

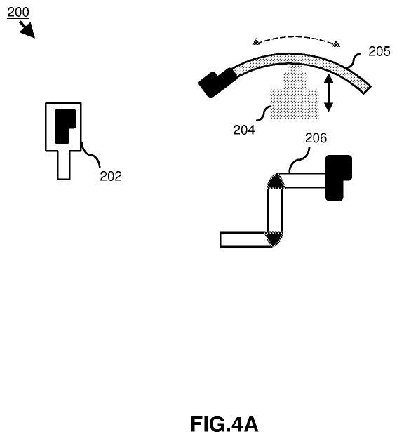

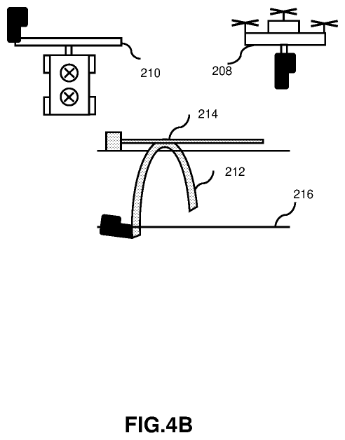

FIGS. 4A and 4B illustrate the various embodiments of using a scanner, in accordance with various embodiments of the present invention;

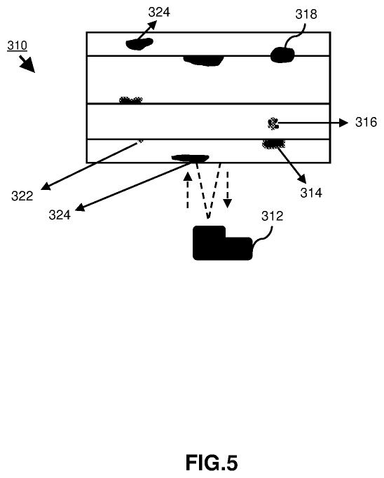

FIG. 5 illustrates a system for scanning of composite material to detect defects, in accordance with various embodiments of the present invention;

FIG. 6 illustrates an embodiment of the virtual array for the RF subsystem including 4 chips;

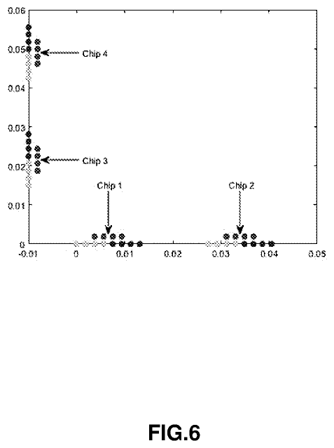

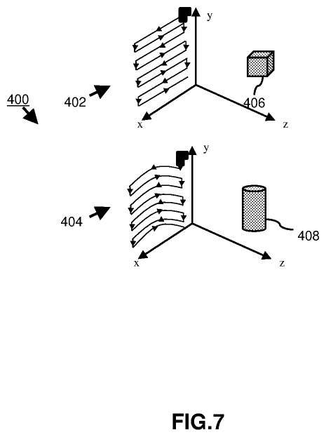

FIG. 7 illustrates a scanning trajectory with respect to target surface, in accordance with various embodiments of the present invention;

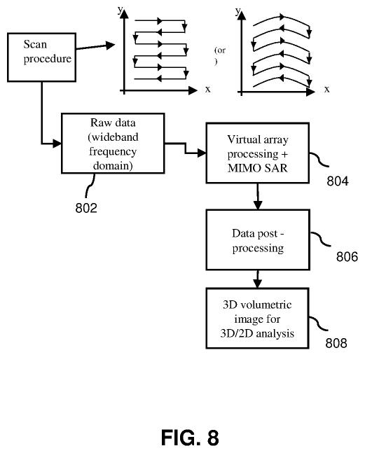

FIG. 8 illustrates a FMCW imaging system employing MIMO SAR techniques for signal processing, in accordance with various embodiments of the present invention;

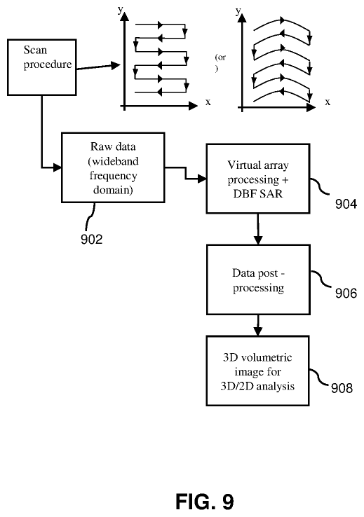

FIG. 9 illustrates a FMCW imaging system employing DBF SAR techniques for signal processing, in accordance with various embodiments of the present invention;

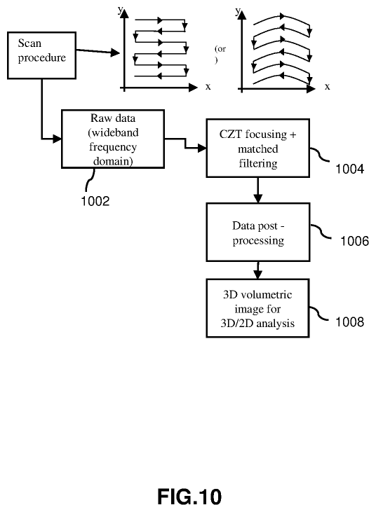

FIG. 10 illustrates a FMCW imaging system employing CZT focusing for signal processing, in accordance with various embodiments of the present invention;

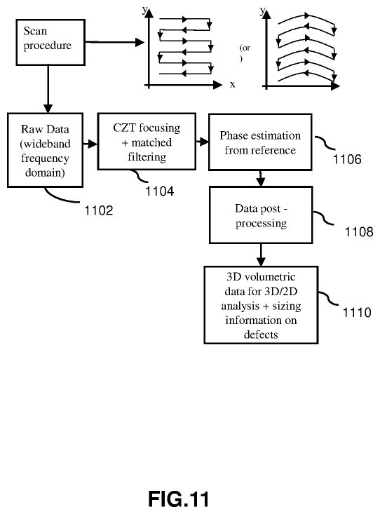

FIG. 11 illustrates a imaging system employing CZT focusing and phase estimation techniques for signal processing, in accordance with various embodiments of the present invention;

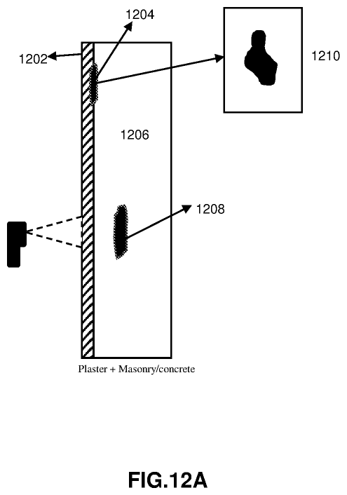

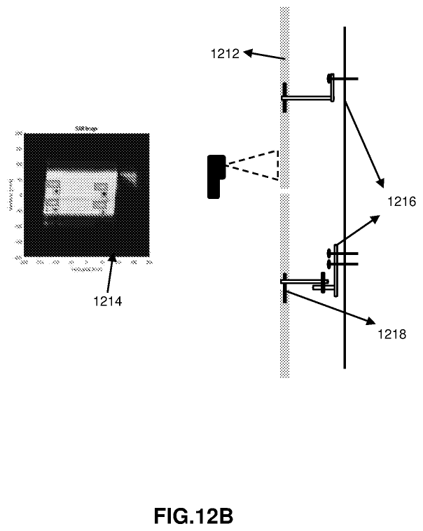

FIGS. 12A and 12B illustrate defects in facade and cladding systems that the system disclosed herein can detect and image;

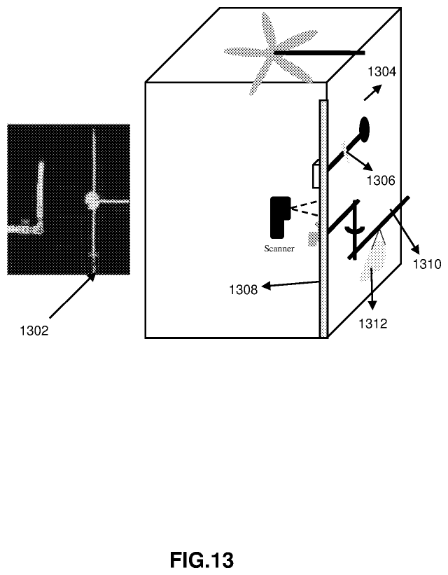

FIG. 13 illustrates hidden mechanical, electrical and plumbing (MEP) utilities and associated defects in such utilities that the system disclosed herein can detect and image;

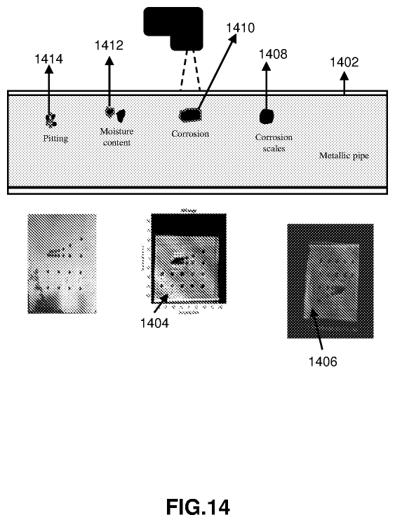

FIG. 14 illustrates defects in oil and gas pipelines in relation to corrosion under insulation (CUI) that the system disclosed herein can detect and image;

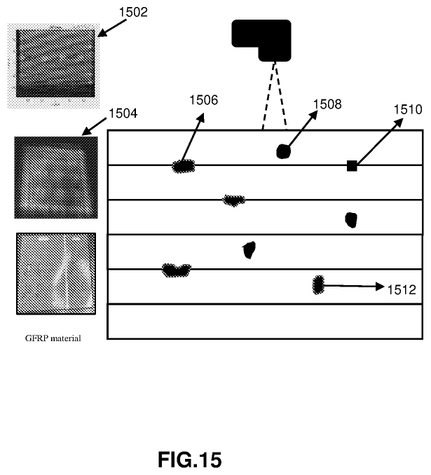

FIG. 15 illustrates defects in aircraft parts that are manufactured using lightweight composite materials;

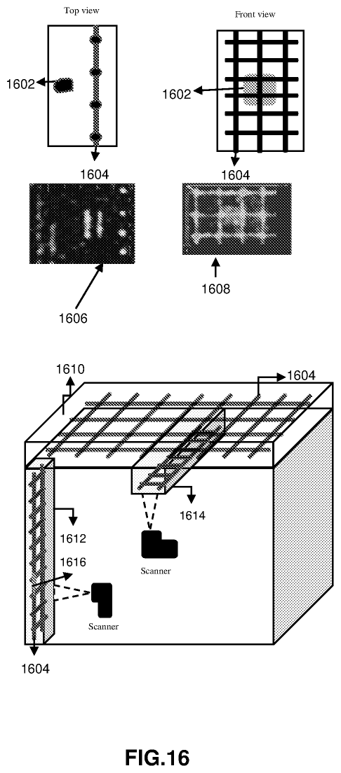

FIG. 16 illustrates defects in structural building elements such as beams, pillars and ceilings in buildings with embedded rebar mesh that the system disclosed herein can detect and image;

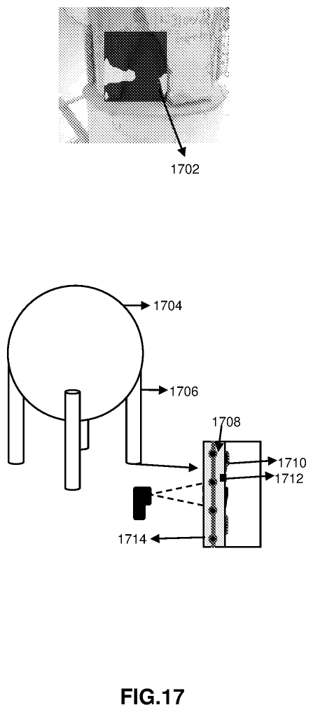

FIG. 17 illustrates defects in legs of spherical tanks in relation to corrosion under fireproofing (CUF) that the system disclosed herein can detect and image;

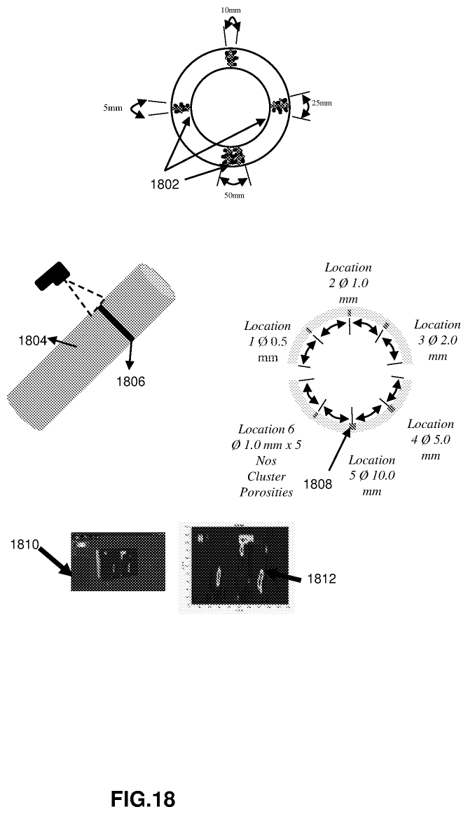

FIG. 18 illustrates defects in welded joints in polyethylene (PE) pipes arising from butt fusion welding or electro-fusion welding that the system disclosed herein can detect and image;

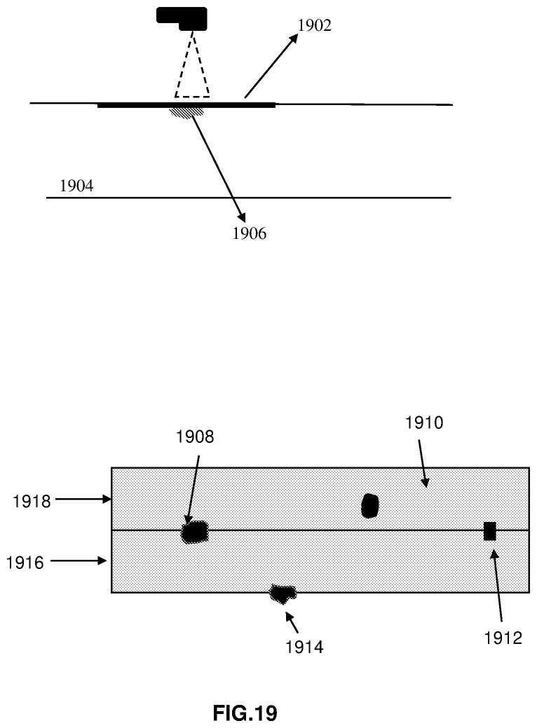

FIG. 19 illustrates detecting defects in composite wraps applied for repair of oil and gas pipelines.

### DETAILED DESCRIPTION

For the purposes of providing an understanding of principles of the invention and the scope of applications involved therein, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

In the following description, algorithms and functions may be shown in block diagram form in order not to obscure the present invention in unnecessary detail. Conversely, specific application implementations shown and described are exemplary only and should not be construed as the only way to implement the present invention unless specified otherwise herein. Additionally, block definitions and partitioning of logic between various blocks are exemplary of a particular implementation. It will be readily apparent to one of ordinary skill in the art that numerous other partitioning solutions may practice the present invention. For the most part, details concerning timing considerations and the like have been omitted where such details are not necessary to obtain a complete understanding of the present invention and are within the abilities of persons of ordinary skill in the relevant art.

The invention describes a mmWave imaging system for realizing a non-contact, non-destructive, high-resolution, see-through imaging scanning solution using propagating electromagnetic waves in the mmWave frequency regime. The testing system according to the invention can have utility in a variety of industries. In order to achieve non-contact imaging using mmWave, a number of component level, system-level, and application-level innovations can be applied. The non-destructive testing of structures in assets refers to the ability of the system disclosed herein to image and evaluate said structure without harming the structure or requiring any disassembly of said structure. In the context of the present invention, “high-resolution” can refer to any achieved image resolution that is lesser than lambda/4 (λ/4) for a certain subset of operating frequency.

For example, the testing system disclosed herein can be used to test and evaluate facades and claddings in order to detect defects such as cracks and corrosion in metallic brackets hidden behind claddings, thus preventing the façade failure due to delamination of facade structures. In another embodiment, the system can be used to test and evaluate the condition of metallic reinforced bar structures (cracks and corrosion in rebar structures) embedded inside concrete beams & pillars, forming the structural blocks of these buildings. In another embodiment, the system can be used to detect defects in mechanical, electrical, and plumbing (MEP) fittings inside buildings to detect maintenance issues such as cracks and corrosion in pipes, water leakage from pipelines, water seepage in concrete and detect the presence of rodents. In another embodiment, the system can be used to test and evaluate the condition of metallic reinforced bar structures (cracks and corrosion in rebar structures) embedded inside concrete pillars and concrete walls. In this regard, the system disclosed herein can be used to identify and quantify cracks and corrosion (spalling) in rebar structures, chloride ingress in concrete and identify/quantify cracks and voids inside concrete structures.

In one embodiment, the system can be used for screening and quantification of corrosion under insulation in oil and gas pipelines. In one embodiment the system can be used for screening and quantification of defects such as voids and interfacial delamination in composite air-craft parts. In another embodiment, the system can be used for screening and quantification of defects in PE pipe welds such as cold fusion, notch defects, foreign particle presence, etc.

All the different modalities of the imaging system are non-contact with the asset to be subjected to said scanning. In the context of the present disclosure “non-contact” refers to there being no physical contact between the system and said asset, whereby there exists a gap/space or stand-off distance of at least one lambda (2) therebetween. The space or stand-off distance between the asset and the testing system can depend on the use case and application scenario. In one embodiment, the stand-off distance can be at least 1 lambda. In one embodiment, the stand-off distance can be at least about 0.01 m, 0.02 m, 0.03 m, 0.04 m, 0.05 m, 0.1 m, 0.2 m, 0.3 m, 0.4 m, 0.5 m, 1 m, 1.5 m or 2 m. In one embodiment, the stand-off distance can be in a range of 0.05 m to 5 m. In one embodiment, the stand-off distance can be in a range 0.5 m to 1 m. In one embodiment, the stand-off distance can be in a range 2 m to 3 m.

In one embodiment, the mmWave image scanning system can operate in a frequency range of 60 GHz to 81 GHz. However, the concepts that are discussed are not limited to the aforementioned frequency range and it can encompass any frequency range between 3 GHz to 300 GHz.

The system and method disclosed herein can generally comprise a computer (i.e. laptop/PC/tablet), an imaging scanner, and optionally an automation platform. For example, the automation platform may not be needed if the imaging scanner is to be used as a handheld device and moved manually by a user. In addition, the system and methods disclosed herein can further include a cloud-based database for receiving and transmitting data to and from the computer.

In an embodiment, the mmWave image scanning system comprises number of sub-systems, including one or more of a RF subsystem, a signal processing subsystem, a software subsystem, an interface subsystem, a localization subsystem and a motion subsystem.

The RF sub-system can be responsible for the transmission and reception of electromagnetic waves in the mmWave spectrum. The signal processing subsystem can be responsible for producing high resolution holographic images, for example 2D and 3D images, based on the backscattered wideband data. In particular, the signal processing subsystem can acquire the coordinate information from the localization subsystem residing in the modality of deployment of the scanner. The interface subsystem can be responsible for interfacing with the software subsystem in a separate tablet/laptop/PC and with robotic platforms such as robotic arm and crawler, and the various subsystems over various wired and wireless interfaces. The software subsystem can be responsible for powerful data visualization, mapping and report generation with AI models running for predictive analysis. The motion subsystem resides in the automation platform and is responsible for the motion of the automation platform in a pre-planned path or an arbitrary path based on the platform involved.

In one embodiment, the system comprises a RF subsystem, a signal processing subsystem and a software subsystem. In another embodiment, the system further comprises an interface subsystem and a localization subsystem.

In one embodiment, the system comprises a RF subsystem, a signal processing subsystem, a software subsystem, an interface subsystem and a localization subsystem.

In one embodiment, the system comprises a RF subsystem, a signal processing subsystem, a software subsystem, an interface subsystem, a localization subsystem and a motion subsystem.

In one embodiment, the system comprises a computer and imaging scanner for hand-held applications. In this regard, a signal processing subsystem and a software subsystem can be located inside the computer, whereas the RF subsystem, an interface subsystem and the localization subsystem can be located inside the handheld scanner, as shown in FIG. 1A. As illustrated in FIG. 1A, the system comprises asset under inspection 132, RF subsystem 134, interface subsystem 142, handheld scanner 136, software subsystem 138, signal processing subsystem 140, localisation subsystem 144.

FIG. 1B illustrates the exchange of information among the laptop/PC/tablet and imaging scanner in constructing the resulting 2D and/or 3D image of the scanned area of an asset. In particular, the PC sends the scan parameters from the scan program to the scanner. Once they receive the scanner parameters, the scanner starts data collection as it is motioned over the asset by a user. Once the scanning is complete, the 3D data is sent for visualisation to the PC where the user interface has capabilities of 3D visualisation and 2D visualisation and AI-based or manual object and defect tagging. As illustrated in FIG. 1B, the system comprises a scan program 146, scan parameters 148, signal processing 150, data collection 152, 3D image 154, AI based defect tagging 156 and 2D image 158.

In one embodiment, the system can comprise a computer, an imaging scanner and an automation platform. In this regard, a signal processing subsystem and a software subsystem can be located inside the computer; a RF subsystem, an interface subsystem and a localization subsystem can be located inside the imaging scanner; and a motion subsystem can be located in the automation platform, as shown in FIG. 2A. FIG. 2A illustrates asset under inspection 132, RF subsystem 134, scanner 136, software subsystem 138, signal processing subsystem 140, interface subsystem 142, localisation subsystem 144, motion subsystem 146.

In one embodiment, the system can comprise a computer, an imaging scanner and an automation platform. In this regard, a signal processing subsystem and a software subsystem can be located inside the computer; a RF subsystem and an interface subsystem can be located inside the imaging scanner; a motion subsystem and a localization subsystem can be located in the automation platform, as shown in FIG. 2B. FIG. 2B comprises of asset under inspection 132, RF subsystem 134, software subsystem 138, signal processing subsystem 140, interface subsystem 142, localisation subsystem 144, motion subsystem 160.

FIG. 2C illustrates the exchange of information among the laptop/PC/tablet, imaging scanner and automation platform in constructing the resulting 2D and/or 3D image of the scanned area of an asset. In particular, the PC sends the scan parameters from the scan program to the scanner and the automation platform. Once they receive the scanner parameters, the scanner starts data collection, and the automation platform starts motion. Once the scanning is complete, the 3D data is sent for visualisation to the PC where the user interface has capabilities of 3D visualisation and 2D visualisation and AI-based object and defect tagging. FIG. 2C comprises of scan program 164, scan parameter 166 in scanner, scan parameter 168 in automation platform, signal processing 170, data collection 172, motion 174, 3D image 176, AI based defect tagging 178 and 2D image 180.

In one embodiment, the imaging scanner can include an enclosure or casing suitable for stand-alone hand-held operations or operations with integration/mounting/fixing with other mechanical/electrical equipment that are collectively termed herein as automation platforms for autonomous/semi-autonomous/controlled imaging dependent on the modality of use. In this regard, the imaging scanner can include insets on an exterior surface of the enclosure suitable for immediate integration/mounting/fixing with automation platforms for coordinated operation. LEDs can be provided on the sides of the enclosure to indicate the status of operation of the scanner along with a power socket and a switch for on/off operation. On the other side, there can be a port and/or wireless transmission components for digital input/output.

In one embodiment, the enclosure or casing of the imaging scanner can include the RF subsystem and the interface subsystem. In another embodiment, the scanner can further comprise the localization subsystem. The enclosure or casing can be made of any suitable material suitable for operation in a desired modality of the system. As readily apparent to a person skilled in the art, the enclosure or casing can be made of any material that does not affect the performance of the electrical equipment and doesn't interfere with the electromagnetic waves.

The enclosure or casing of the scanner can be any suitable shape or size depending on the mode of use. In one embodiment, the enclosure or casing can be of any suitable size in the range of about 15×15×5 cm to about 25×25×10 cm. In another embodiment, the enclosure or casing can be substantially square shaped with dimensions of about 20 cm×20 cm×5 cm.

The embodiments of the image scanning systems of the invention have been further explained in the following sections. Particularly the mmWave image scanning system and the subsystems of the image scanning system have been further explained in detail in the following description.

FIG. 3A illustrates an overview of the system 100a having a hand-held imaging scanner and scanning an asset such as an oil & gas pipeline, in accordance with various embodiments of the present invention. As shown in FIG. 3A, the system 100 has a user interface 102 of a laptop 104, an imaging scanner 108, whereby a void 110 on the asset, an interfacial delamination 112 on the asset, corrosion 114, composite wrap 116, scaling 118, and insulation 120 and 122 are able to be detected, identified and/or quantified through 2D and/or 3D visualisation. The laptop 104 can be connected to a cloud-based database 124 via a wireless or wired interface (interface 2). The imaging scanner 108 can identify and quantify the corrosion and other defects such as interfacial delamination 112 and internal voids 110.

The imaging scanner can perform the scanning procedure in a certain trajectory and return the raw data through a wireless or wired interface (interface 1) to the user interface 102 residing in the laptop 104 where 3D visualization, 2D visualization can be performed and further data interpretation is completed manually or through an automated process, such as machine learning (ML)/artificial intelligence (AI) predictive analysis.

Accordingly, in one embodiment, there is provided an imaging system comprising a computer and an imaging scanner in communication with each other to provide 3D/2D visualisation and analysis of a scanned area. More specifically, the system can include a RF subsystem configured with multiple transceiver channels for transmitting and receiving electromagnetic waves in mmWave spectrum; a signal processing subsystem for producing high resolution holographic images based on backscattered wideband data; and a software subsystem for 3D/2D visualisation and analysis.

FIG. 3B illustrates an overview of the system 100b having the scanner mounted on an automation platform, in this instance a robotic arm, and scanning an asset such as an oil & gas pipeline, in accordance with various embodiments of the present invention. As shown in FIG. 3B, the system 100 has a user interface 102 of a laptop 104, a robotic arm 106, an imaging scanner 108, whereby a void 110 on the asset, an interfacial delamination 112 on the asset, corrosion 114, composite wrap 116, scaling 118, and insulation 120 and 122 are able to be detected, identified and/or quantified through 2D and/or 3D visualisation. The laptop 104 can be connected to a cloud-based database 124 via a wireless or wired interface (interface 3). The imaging scanner 108 can identify and quantify the corrosion and other defects such as interfacial delamination 112 and internal voids 110. In one embodiment, the scanner 202 is integrated with the robotic arm 206 with multiple degrees of freedom.

The scanner and automation platform (i.e. robotic arm) can perform the scanning procedure in a certain trajectory and return the raw data through a wireless or wired interface (interface 1 and 2) to the user interface 102 residing in the laptop 104 where 3D visualization, 2D visualization can be performed and further data interpretation is completed manually or through an automated process, such as machine learning (ML)/artificial intelligence (AI) predictive analysis.

Accordingly, in one embodiment, there is provided an image scanning system comprising a computer, an imaging scanner and an automation platform in communication with each other to provide 3D/2D visualisation and analysis of a scanned area. More specifically, the system can include a RF subsystem configured with multiple transceiver channels for transmitting and receiving electromagnetic waves in mmWave spectrum; a signal processing subsystem for producing high resolution holographic images based on backscattered wideband data; and a software subsystem for 3D/2D visualisation and analysis.

FIG. 4A-B illustrates various embodiments 200 of an imaging scanner, in accordance with various embodiments of the present invention. FIG. 4A-B illustrates a hand-held scanner 202, a telescopic lifter 204, a robotic arm 206, a drone 208, a crawler 210, a rail 212, a lead screw 214 within a pipe 216. The form factor of the hand-held scanner 202 can be configured such that the localization subsystem resides inside the scanner equipment which performs dynamic self-localization. The scanning process can be manual or automated.

The imaging scanner 202 can also be integrated with other automated platforms, other than robotic arms. The rail-based platform having the telescopic lifter 204 is a modality where in the vertical motion is achieved by a telescopic pneumatics-based lifter 204 and the curved motion is obtained using a curved rail 205 on which the imaging scanner 202 runs. Such a configuration is used in the identification of corrosion under fireproofing (CUF) in legs of spherical tanks. The rail-based platform having the rail 212 may also work with two rails instead of a telescopic lifter 204 for one of the axes.

In another embodiment, the imaging scanner 202 is integrated with the crawler 210 and the crawler 210 is operated based on a suction principle, or a magnetic principle, etc. Such a configuration is deployed for applications requiring Work At Height (WAH) such as façade inspection, inspection of large oil containers, etc. In one embodiment, the scanner 202 is integrated together with the drone 208.

FIG. 5 illustrates a system 310 for scanning of composite material to detect defects, in accordance with various embodiments of the present invention. As shown in FIG. 5, the scanner 312 scans the composite material for dis-bonds 314, porosity 316, interfacial delamination 318, voids 320, foreign particles 322, and water ingress 324.

In one embodiment, the invention discloses a method for obtaining an image of an area under testing using the system as described above, the method comprising the steps of: combining data from RF subsystem and a localisation subsystem by the signal processing subsystem to perform 3D/2D image reconstruction algorithms and data interpretation schemes which are routed to localisation subsystem; routing the data interpretation and reconstructed 3D/2D image through the interface subsystem to a software subsystem AI predictive analysis through wired or wireless transmission to visualise the image of area under testing.

In another embodiment, the invention discloses a method of identifying defects in various kinds of assets including infrastructure, oil & gas pipelines, aircraft parts, shipping vessels, storage tanks, manufacturing, logistics and power plants by deploying the image scanning system disclosed herein.

Moreover, in another embodiment, the invention discloses a computer readable storage medium having stored thereon, computer readable instructions, when processed by a processor, cause a system to execute the method disclosed herein.

### RF Subsystem

The RF subsystem can obtain a raw data information, for example, electromagnetic waves from an object or asset under inspection. The RF subsystem can be operationally connected to a signal processing subsystem to allow for the RF subsystem to transmit raw data to the signal processing subsystem for further processing and to obtain holographic images.

In one embodiment, the RF subsystem can operate in a frequency range of 3 GHz to 300 GHz. In another embodiment, the RF subsystem can operate in a frequency range of 60 GHz to 81 GHz. In another embodiment, the RF subsystem can operate in a frequency range of 77 GHz to 81 GHz.

The RF subsystem can be designed with multiple transceiver channels employing millimetre wave transceiver Integrated Circuits (ICs) as one of the building blocks. The transceiver IC can be an integrated single-chip frequency modulated continuous wave (FMCW) radar sensor capable of operation in the frequency band of 60 to 81 GHz. The RF subsystem can incorporate a high-performance mm-wave front-end with an integrated processor and a hardware accelerator.

In one embodiment, the RF subsystem can comprise a cascade of multiple printed circuit board (PCBs) with the ICs thereon, which in turn increases the number of RF channels. In an embodiment, this can be through wired interfaces such as UART, SPI or I2C.

In one embodiment, the RF subsystem can be designed with multiple transceiver channels employing mmWave transceiver ICs. In one embodiment, the transceiver IC can be an integrated single-chip frequency modulated continuous wave (FMCW) radar sensor capable of operation in the frequency band of 60 to 81 GHz.

In one embodiment, the transceiver IC can comprise a transceiver SoC (System on Chip).

In one embodiment, the RF subsystem can be modular, for instance, instead of a SoC, each functionality may be achieved through discrete components. Additionally, other SoCs may be used to achieve functionality of pulsed radar/SFCW technique.

In this regard, the system can incorporate a high-performance mmWave front-end with an integrated processor and a hardware accelerator.

In one embodiment, the number of channels can be generalized to NXM channels, where N is the number of transmitter channels and M is the number of receiver channels. As an example, having higher number of channels, reduces the scan time for a given area.

In one embodiment, the RF subsystem can comprise at least one single chip with 12 transceiver channels (3 Transmitters×4 Receivers).

In one embodiment, the RF subsystem can comprise two transceiver IC chips that have been integrated to work together to provide 24 transceiver channels (2×(3 Transmitters×4 Receivers)).

In one embodiment, the RF subsystem can comprise three transceiver IC chips that have been integrated to work together to provide 36 transceiver channels (3×(3 Transmitters×4 Receivers)).

In one embodiment, the RF subsystem can comprise four IC chips that are integrated to work together so that there are 48 channels in total, which in turn drastically reduces the inspection time as well as improves the resolution of imaging. In particular, the RF subsystem can comprise 4 transceiver ICs. In this embodiment, each chip can have 3 TX and 4 RX channels, thus providing 12 virtual antenna elements. Accordingly, the RF subsystem can comprise a total of 4 times (3TX and 4RX channels), giving a combined capacity of 48 virtual elements.

In one embodiment, the RF subsystem can comprise four chips and 48-channels for applications that require millimetre scale resolution in x-axis, y-axis and z-axis with acceptable speed of inspection.

In one embodiment, the transceiver IC can comprise a transceiver SoC. The single transceiver SoC can comprise M=3 transmit antenna elements (Tx1, Tx2 and Tx3) and N=4 receive antenna elements (Rx1, Rx2, Rx3 and Rx4). In one embodiment, each single transceiver SoC can comprise 12 virtual antenna elements. Each virtual antenna element can be treated as an individual monostatic element that can collect equivalent data compared to the physical array. The virtual array can be beneficial as it is only half the size of the actual physical array, but it gives exactly an equivalent amount of information. To create a virtual array architecture, receiver antennas must be able to separate the signals corresponding to different transmitter antennas, which is done on-board.

In this regard, the SoC can be interchangeable with the transceiver IC and single chip.

In one embodiment, each chip can comprise TX1 and TX3 can be on the azimuth plane and are separated by a distance of 2λ, while the TX2 can be located on the elevation plane and is separated by a distance of λ/2. The TX1 and TX3 can be separated by a distance of A from TX2.

In one embodiment, the RF subsystem can comprise an antenna arrangement with two chips (Chip 1 and Chip 2) oriented along the x-axis, while the other two chips (Chip 3 and Chip 4) oriented along y-axis, as shown in FIG. 6. This configuration can maximise the amount of scanning area within a much lesser time. In other words, this can help in enhancing the speed at which an area is scanned for defects and reduce the time it takes to scan that area by ¼th in comparison to a single chip.

By making the use of multiple chips, the overall imaging process can be speeded up, without compromising on the image resolution. By adding a second chip (Chip 2) along the azimuth plane, a scanning of the same object or asset under inspection there is no compromise on the image resolution and simultaneously, the scanning time is twice as fast.

In one embodiment, an algorithm can be used to make use of all the four chips (48 virtual channels) scan the same object or asset under inspection, whereby a step size of Δx=8 mm,Δy=8 mm can be used. In comparison to a scan with 24 virtual channels, the time taken to scan is almost ⅛th when using all the four chips (48 virtual channels). This advantageous effect can be attributed to the addition of two chips along the elevation plane, whereby the resolution of the smaller holes or defects can become much clearer in comparison to the scan with 24 virtual channels.

In one embodiment, the antenna elements in the Receiver (Rx) array and Transmitter (Tx) array can comprise square, disc, rotated square, and metamaterial-based zeroth order antennas. The antenna elements can be implemented using a variety of different antenna types based on application requirements. The defining features of an antenna element include the return loss, radiation pattern, efficiency, gain, half power beamwidth (HPBW), polarization and form factor.

For example, in a MIMO FMCW radar system, it is desirable for the antenna elements to have a large field of view/Half Power Beam Width (HPBW), considerable gain, high efficiency, planar configuration and low form factor. Planar antenna configurations include microstrip patch antennas (square, disc, rotated square, etc.), coplanar and other strip-line based configurations. Special techniques such as the design of metamaterial-based zeroth order antennas can also be employed in order to miniaturize the antenna element and also to achieve other special characteristics in accordance with the application requirements.

### Signal Processing Subsystem:

The signal processing subsystem can be responsible for producing high resolution holographic images, for example 2D and 3D images, based on the backscattered wideband data received from the RF subsystem. The signal processing subsystem can employ various techniques in processing the data obtained from RF subsystem.

In conventional and current technologies (e.g. SISO SAR), a single channel mmWave scanner system is typically used, where the system takes a long period (e.g. 1 hour) to scan a given area. As will be appreciated, a long time frame is not desirable or presents a viable solution in the real-world scenario.

In one embodiment, the signal processing subsystem can comprise and employ one or more techniques including but not limited to MIMO (Multiple Input Multiple Output), MIMO SAR (Multiple Input Multiple Output Synthetic Aperture Radar), Digital beamforming (DBF), DBF and synthetic aperture radar (SAR), Chirp-Z-Transform (CZT) Focusing, phase analysis, and/or combinations thereof.

### MIMO and MIMO SAR

In one embodiment, the signal processing subsystem can comprise MIMO (Multiple Input Multiple Output). In one embodiment, ‘MIMO SAR (Multiple Input Multiple Output Synthetic Aperture Radar)’ technique can be employed in the signal processing subsystem.

FIG. 7 illustrates scanning trajectories 502 and 504 with respect to target surface of an object or asset 506 for inspection. To reconstruct an image, the data can be collected at each spatial sampling point by moving the scanner along a fixed trajectory in the x-y plane. This can apply a technique called ‘multiple input multiple output (MIMO) SAR. The motion of scanning can be manual with feedback of coordinate information from the localisation subsystem. The motion can be automated on a robotic platform such as a drone, UGV, wherein the coordinate information may come as feedback from the localisation subsystem in the automated platforms. In case of a cylindrical profile for the asset 508, the scanner is moved in along a trajectory in accordance with the profile of the asset. For example, in case of the cylindrical profile, the scanner is moved in a curved trajectory.

For any given MIMO SAR signal processing subsystem, the RF subsystem can include a virtual array of at least one SoC (System on Chip).

In one embodiment, the signal processing subsystem can comprise MIMO SAR and the RF subsystem can include a virtual array of at least one SoC with 24 Channels.

In one embodiment, the signal processing subsystem can comprise MIMO SAR and the RF subsystem can include a virtual array of at least one SoC with 48 Channels.

An exemplary flow chart that combines MIMO SAR in the system disclosed herein is shown in FIG. 8. FIG. 8 illustrates the flow chart for an algorithm that combines MIMO SAR.

As shown in FIG. 8, raw data is acquired over a 2D aperture at block 802. In the next step, a virtual array processing using MIMO SAR is executed at block 804. Subsequently, post-processing of data is carried out at block 806. At block 808, 2D IFFT is executed for each zi (zi refers to the depth value) for image reconstruction to obtain the focussed 3D image. FIG. 8 comprises of raw data 802, virtual array processing+MIMO SAR 804, data-post processing 806, 3D volumetric image for 3D/2D analysis 808.

In the MIMO SAR signal processing subsystem, the number of measurement points in x and y are represented in the frequency domain as kₓ and k_{y} respectively. For a N-point FFT in x and y, with a step size of nₓ and n_{y}, a corresponding frequency in wavenumber domain obtained (kₓ=2πfₓ and k_{y}=2πf_{y}).

The MIMO SAR signal processing subsystem can first denote a vector based on the physical location of the antenna elements. This can be given by measuring the physical distance between each of the transmitter and receiver element and the vector can be represented as dlₓ and dl_{y} for x and y axes respectively. Upon defining that, the virtual element spacing between each of the antenna must be defined.

For example, where each single transceiver SoC of the RF subsystem comprises 12 virtual elements, each of the TX elements can be separated by λ, while the RX elements are separated by λ/2. Thus, each of the virtual element (L=12) in the array would be separated by a λ/2 spacing along one of the axes (azimuth plane). Out of 12 virtual elements, 8 elements can lie on (0, y), while the elements corresponding to TX2 can lie at

$$( \frac{λ}{2} , y ) .$$

The virtual element position vector is denoted by x1 and y, respectively. Using the definition of Fourier transforms, one can express the 2D wavenumber spectrum of the sampled signal associated with the channel.

If the spatial sampling criterion is not met, then aliasing/ghosting occurs when the image is reconstructed. Accordingly, the MIMO SAR signal processing subsystem can construct alias-free images by combining information from multiple sub-channels. In particular, a complex gain vector (or weighting vector) can be chosen in such a way that the ghost images can be cancelled, while combining information from multiple channels.

The resulting MIMO SAR image can be reconstructed using a MIMO SAR image reconstruction algorithm summarised as performing the following steps performed in the signal processing system:
Gather uniformly sampled complex FMCW data cube r(x, y, t) from transceiver over a 2D planar aperture for all the virtual sub-channels;
Perform range focusing at distance z0 to the target and obtain uniformly sampled complex data;
Define the physical virtual antenna element positions;
Compute the matched filter;
Determine the corresponding weighting vector for each of the virtual sub-channels;
Multiply the weighting vector and then with the matched filter; and
Perform the 2D IFFT (inverse fast fourier transform).

### DBF and SAR

Beamforming refers to a signal processing technique used in antenna array for directional signal transmission and reception (to steer the beam in intended direction). Digital beamforming can be combined with synthetic aperture radar (SAR) techniques to obtain faster scanning without compromise in resolution.

Accordingly, in one embodiment, the signal processing subsystem can comprise digital beamforming. In another embodiment, the signal processing subsystem can comprise digital beamforming and synthetic aperture radar. In one embodiment, ‘Digital beamforming (DBF)+SAR’ technique can be employed in the signal processing subsystem.

Digital beamforming can be based on the conversion of the RF signal at each antenna elements into two streams of binary baseband signals representing cos and sin channels. These two digital baseband signals can be used to recover both the amplitudes and phases of the signals received at each element of the array. The process of digital beamforming implies weighting by a complex weighting function and then adding together to form the desired output. Beam steering in DBF can be easily achieved by using signal processing techniques in digital domain, which reduces the need of components utilised in analog beamforming (ABF) such as phase shifters, time delay lines and attenuators.

In one embodiment, the digital beamforming can comprise a minimum variance distortion-less beamformer (MVDR) that is a beamforming method that overcomes the interference problem associated with conventional delay and sum beamforming. This preserves the signal from desired direction and suppresses all the signals coming from other directions.

In one embodiment, linear constraint minimum variance (LCMV) beamformer can be used in addressing the self-nulling problem evident in the MVDR scheme. This beamformer can allow input of multiple constraints for desired direction (target direction). Upon defining a 2D or 3D matrix of element positions, the steering angle can be defined. A maximum and minimum limit can be set (in degrees), along with an angular step size, which will increase over each iteration. By defining the steering angle vector, each antenna element can be digitally steered along that angular direction with the given angle step size. A sensor covariance matrix can be defined based on the antenna element positions and the maximum acceptable azimuth and elevation angle limits. Once the sensor covariance matrix and the steering vectors are obtained, the gains for the weighting vector can be found. The weighting vector is then multiplied with the received data from each of the virtual channels to obtain the digitally steered backscatter data.

In one embodiment, the signal processing subsystem can comprise DBF SAR and the RF subsystem can include a virtual array of at least one SoC with 24 Channels.

In one embodiment, the signal processing subsystem can comprise DBF SAR and the RF subsystem can include a virtual array of at least one SoC with 48 Channels.

An exemplary flow chart that combines DBF SAR in the system disclosed herein is shown in FIG. 9. FIG. 9 illustrates the flow chart for an algorithm that combines DBF SAR. As shown in FIG. 9, raw data is acquired over a 2D aperture at block 902. In the next step, a virtual array processing using DBF SAR is executed at block 904. Subsequently, post-processing of data (i.e. 2D IFFT is performed for each zi) is carried out at block 906. At block 908, image reconstruction is performed to obtain the 3D image. FIG. 9 comprises of raw data 902, Virtual array processing+DBF SAR 904, Data post-processing 906, 3D volumetric image for 3D/2D analysis 908.

Below Table 1 provides a comparison of the performance of various SAR techniques (MIMO v DBF v SISO) that can be employed in the system disclosed herein.

The SISO system in the below table comprises one transmitter and one receiver channel.

It can be seen 48-channel mm-wave scanner powered with MIMO SAR is capable of performing quick inspection (imaging) maintaining a sub-mm level resolution. However, by using the DBF+SAR algorithm for 24 virtual channels with a step size of Δx=1 mm, Δy=10 mm the scanning time can be completed within 4 minutes.

TABLE 1
Imaging performance

| Performance | | | MIMO SAR | | MIMO SAR | | DBF + SAR | | DBF + SAR | |
|---|---|---|---|---|---|---|---|---|---|---|
| characteristics | SISO SAR | | (24 channel) | | (48 channel) | | (24 channels) | | (48 channels) | |
| Number of | 1 | | 24 | | 48 | | 24 | | 48 | |
| channels | | | | | | | | | | |
| Area of scan | 225 | cm² | 225 | cm² | 225 | cm² | 225 | cm² | 225 | cm² |
| Time of scan | 2 | hrs | 8 | minutes | Under 1 | | 4 | min | Under 1 | |
| | | | | | minute | | | | minute | |
| Resolution | 1 | mm | 1 | mm | 1 | mm | 5 | mm | 5 | mm |
| (Smallest hole | | | | | | | | | | |
| dimension) | | | | | | | | | | |

### Chirp-Z-Transform (CZT) Focusing for 3D Imaging

In one embodiment, ‘Chirp-Z-Transform (CZT) Focusing for 3D Imaging’ technique can be employed in the signal processing subsystem.

Range resolution can be dependent on the chirp bandwidth B. In case of a system with a bandwidth of 20 GHz, the range resolution,

$${R}_{res} = \frac{c}{2 B} = 7.5 mm .$$

However, in applications such as the detection of corrosion under insulation (CUI) in oil & gas pipelines, a range accuracy of close to 1 mm is desired as the typical wall thickness is less than 10 mm. To achieve such a range accuracy in the present disclosure, a range compensation mechanism based on chirp-Z-transform can be chosen. The CZT is a generalization of the discrete Fourier transform (DFT).

While the DFT samples the Z-plane at uniformly-spaced points along the unit circle, the chirp Z-transform samples along spiral arcs in the Z-plane, corresponding to straight lines in the S-plane. In one embodiment, the raw data obtained from all the channels can be in the frequency domain between 60 GHz to 81 GHz.

In this regard, CZT can be used to compute the complex values at any given value of time (any given value of range z) upon which matched filtering and image reconstruction can be performed to obtain the focussed 3D image.

Accordingly, in one embodiment, the signal processing subsystem can comprise Chirp-Z-Transform (CZT) techniques. In one embodiment, the CZT technique can be used in a FMCW radar system.

In one embodiment, the signal processing subsystem can comprise CZT focusing and the RF subsystem can include a virtual array of at least one SoC with 24 Channels.

In one embodiment, the signal processing subsystem can comprise CZT focusing and the RF subsystem can include a virtual array of at least one SoC with 48 Channels.

An exemplary flow chart that combines CZT focusing in the system disclosed herein is shown in FIG. 10. FIG. 10 illustrates the flow chart for an algorithm that combines CZT focusing. In an embodiment, with such an algorithm a range accuracy of sub-mm scale can be obtained.

As shown in FIG. 10, raw data is acquired over a 2D aperture at block 1002. In the next block 1004, a range focusing at zi is executed using CZT followed by matched filtering for azimuth focusing at block. Then data post-processing is performed at block 1006. At block 1008, the step of thresholding and filtering for image reconstruction is executed to obtain a focussed 3D image. FIG. 10 comprises of raw data 1002, CZT focusing matched filtering 1004, data post-processing 1006, 3D volumetric image for 3D/2D analysis 1008.

### Phase Analysis

In one embodiment, a ‘phase analysis’ technique can be employed in the signal processing subsystem.

The phase estimation can be combined with the CZT based focusing to achieve sub mm-scale quantification in x-axis, y-axis and z-axis. Accordingly, in one embodiment, the signal processing subsystem can employ CZT based focusing in combination with ‘phase analysis’.

In one embodiment, the signal processing subsystem can comprise CZT focusing and phase analysis, and the RF subsystem can include a virtual array of at least one SoC with 24 Channels.

In one embodiment, the signal processing subsystem can comprise CZT focusing and phase analysis, and the RF subsystem can include a virtual array of at least one SoC with 48 Channels.

Quantification and sizing of defects in the objects and assets under inspection is critical for decision making as part of regular inspection & maintenance. For example, in the NDT for detecting corrosion under insulation and henceforth the sizing of corrosion in x, y and z axis is vital. The magnitude information is not sufficient to accurately size defects in the range direction (z-direction). The phase information resulting from the complex 3D matrix is important as well. In a real-world scenario, these types of corrosion patterns can be found to be hidden under insulation on metallic pipelines/containers/shipping vessels/legs of spherical tanks, etc.

FIG. 11 illustrates a process for defect analysis to obtain sizing accuracy in mm-scale in all three axis utilising both CZT and phase analysis. At block 1102, raw data is acquired over a 2D aperture and subsequently at block 1104 CZT focusing is performed with matched filtering for azimuth focusing. Phase estimation from reference is executed at block 1106. At block 1108, data post-processing is performed, including 2D IFFT being performed for each zi. At block 1110, 3D volumetric data for 3D or 2D analysis is combined with sizing information on defects. Thereafter, an additional step can be performed of subtracting angles is executed and modulation is performed at 360 degrees to obtain a phase plot. FIG. 11 comprises of raw data 1102, CZT focusing matched filtering 1104, phase estimation from reference 1106, data post-processing 1108, 3D volumetric data for 3D/2D analysis and sizing information on defects 1110.

### Localisation Subsystem:

The localisation subsystem can obtain the coordinate information of the imaging scanner and automation platform, if present. The localisation subsystem can communicate and receive coordinate information from both the signal processing and interface subsystems. The localisation subsystem is responsible for collecting the coordinate information and propagating this information to the interface subsystem.

In particular, the RF subsystem is responsible for transmitting and receiving electromagnetic waves over a wide frequency spectrum (eg. 77 GHz to 81 GHZ). The interface subsystem can be connected to the RF subsystem, whereby data from the RF subsystem is transferred to the interface subsystem which also collects the spatial coordinate information from the localisation subsystem over a wired/wireless interface. The coordinate information and the raw data can be transferred to the signal processing subsystem which processes the information to produce 3D volumetric images for analysis in the software subsystem.

Coordinate information is critical for accurate 2D or 3D image reconstruction. The coordinate information can be obtained from the localisation subsystem. Accordingly, the interface subsystem can obtain the coordinate information from the localisation subsystem and communicates this information to the signal processing subsystem for accurate 3D/2D image reconstruction.

In one embodiment, the localisation subsystem can comprise one or more sensors including but not limited to inertial measurement unit (IMU), optical flow sensors, stereo cameras, lidars and encoders. In one embodiment, the IMU can be used to determine the orientation of an object and in combination with other sensors for odometry to dynamically self-localize.

In one embodiment, the localisation subsystem can comprise a IMU, encoder based odometry, lidar and laser based scanner.

In one embodiment, the localisation subsystem can physically reside in the image scanner (FIG. 1A). In another embodiment, the localisation system can reside in the automated platform (FIG. 2B). In certain automation platforms such as a robotic arm, encoders can be included in the robotic arm that act as the localisation subsystem.

### Software Subsystem:

The software subsystem communicates and receives information from both the signal processing and interface subsystems, as well as a user interacting with the system via a user interface. The information can include the scan parameters like scan area, stand-off distance, material scanned, etc. Moreover, raw data cube and some handshake signals can be communicated to the software subsystem.

In one embodiment, the software subsystem can include software programmes responsible for one or more of the following functions:
3D and 2D visualisation;
Mapping and overlay of obtained scan information on actual asset of inspection;
Cloud storage and automated reporting;
AI based defect detection, tagging and tracking for predictive analysis to assess the condition of the asset.

In one embodiment, the software subsystem can comprise a software application for a user to interface and interact with.

In one embodiment, the software subsystem can comprise software programmes for 3D/2D visualisation and analysis.

The software programmes can comprise tools for 3D visualisation including slicing in multiple dimensions, different perspectives/view options for the 3D image and different colouring options for ease of visually distinguishing various features. In 2D view, an AI based defect tagging and detection can be deployed for ease of data analysis. AI based tagging can be done in post-processed data for 2D as well as 3D data. This AI driven data analysis represents an enhanced optional feature, whereby the software programmes themselves can be fully functional with manual analysis and tagging without AI analysis.

In one embodiment, the software programmes can possess the capability of geo-tagging the object or asset under inspection and overlay of the object/asset images/3D digital twins with scanned 3D images. The 3D analysis can be applied to 3D images.

In one embodiment, the software subsystem can allow for all the defects that are detected during the inspection of an asset to be logged and tracked over time to realize a predictive analysis system that can proactively assess the safe remaining lifetime of the asset.

In one embodiment, the software subsystem can comprise one or more software programmes that enable AI and predictive analysis of data from the RF subsystem and a localisation subsystem.

In one embodiment, the software subsystem comprises a matched filter in order to reconstruct a 2D or 3D image from the recorded data of the signal processing subsystem. In particular, in an embodiment where the signal processing subsystem employs a MIMO SAR technique, a matched filter can be slightly different from that of a single channel, as it is represented in the wavenumber domain, while the latter is represented in the spatial domain. A matched filter with respect to the number of measurement points in x and y axes respectively, can be constructed.

### Interface Subsystem:

The interface subsystem is connected to the RF subsystem whereby data from the RF subsystem is transferred to the interface subsystem which also collects the spatial coordinate information from the localisation subsystem over a wired/wireless interface.

In one embodiment, the interface subsystem can be responsible for interfacing with the various existing subsystems to ensure optimal scanner system performance. It is also responsible for interfacing with the software subsystem in a separate tablet/laptop/PC (i.e. computer) and with robotic platforms such as robotic arm and crawler. The hardware is usually a microcontroller board with peripherals for various wired and wireless interfaces including UART, SPI, I2c, peer2peer WiFi, etc.

In one embodiment, the interface subsystem can communicate the processed data from the signal processing subsystem to the software subsystem routed to the localisation subsystem via wireless TCP/IP connection (WiFi P2P).

In one embodiment, the synchronisation of data acquisition and the motion of mobile platform (in case of automation) can be realized by the interface subsystem either through UART or digital I/O.

In one embodiment, the interface subsystem can be completely wired or wireless depending on the application scenario.

### Examples

Non-limiting embodiments of the invention will be further described in greater detail by reference to specific Examples, which should not be construed as in any way limiting the scope of the invention.

The list provided herein is not an exhaustive list of applications. However, wherever an inspection involves the inspection of metallic surface hidden underneath a non-metallic medium with a given permittivity and permeability (or) the volumetric inspection of a non-metallic medium with a given permittivity and permeability the mmWave based holographic imaging can be deployed based on the application requirements.

### Building and Infrastructure (Facade Inspection):

One of the common types of defects that occur in facades and cladding systems is the deterioration of the metallic brackets holding the cladding system, as shown in FIGS. 12A and 12B. In one embodiment FIG. 12A comprises of plaster 1202, delamination 1204, masonry/concrete 1206, void 1208, area percentage of delamination 1210. FIG. 12 B comprises of stone cladding 1212, 2D image of metallic bracket 1214, restraint bracket 1216, links 1218.

Failure of the brackets are critical since it will lead to the collapse of the cladding structure. FIG. 12A illustrates a stone cladding structure with metallic brackets. In an embodiment, the scanner system can be used for facade inspection. In plaster/masonry walls defects such as voids and delamination can be detected and the area percentage of delamination can be quantified.

In stone cladding systems, defects such as missing links/brackets, deterioration (cracks/corrosion) in links can be detected. A metallic bracket concealed behind stone cladding of thickness 4 cm was scanned using the mmWave scanner. The scan area was 24 cm*24 cm and the total scan time was close to 2 minutes. The scanned image is shown in FIG. 12B for scanned metallic bracket hidden behind stone cladding. It can be seen that the scanned image shows the metallic bracket with number of holes detected and tagged by the defect recognition algorithm. This is a clear indication of the capability of the scanner to detect and monitor metallic brackets concealed behind stone claddings.

The scanner system can be used for detection of cracks in facades, delamination of cladding systems, detection of cracks and corrosion in rebars embedded in structural pillars as well as in floors and ceilings. In the FM (Facility management) industry, locating hidden pipelines and wiring becomes critical to localise defects such as water leakage and breakage of wires. In the current inspection practice there is no way to localise and track these defects. The current practice is to remove the entire partition wall/dry wall for localising the defects before repair and replacement. The inventive system scanned a 60 cm×60 cm area of a dry wall concealing a water pipeline and an electrical conduit. The water pipe had a hole and the electrical wire had a breakage induced in them.

FIG. 13 illustrates an indoor inspection where the system can be used in detecting pipelines, wire conduits running behind gypsum walls/concrete/brick wall. In another embodiment FIG. 13 comprises of 2D scanned image of water pipe and electrical conduit 1302, wiring 1304, breakage of wire 1306, gypsum wall 1308, water pipes 1310, water leakage 1312.

The scanner system is useful in detecting defects such as cracks in water pipes and breakage of wires. The scanned mm Wave image is shown in FIG. 13 whereby the water pipe is tagged with an identified ‘hole’ and the electrical wire tagged with an identified ‘breakage’, both of which are clearly resolved by the system.

In one embodiment FIG. 14 comprises of insulation 1402, 2D image 1404, 3D image 1406. Further, FIG. 14 illustrates corrosion scales 1408, corrosion 1410, moisture content 1412, and pitting 1414 in a metallic pipe.

### Oil and Gas Pipelines/Containers and Shipping Vessels:

The metallic structures in oil and gas containers and shipping vessels, as shown in FIG. 12 undergo the natural ageing process and are subject to defects such as cracks, corrosion and pittings. Earlystage detection of minute defects in the mm-scale are critical in such industrial verticals. Present mmWave imaging and inspection system is suitable for such applications providing unique value propositions such as the capability to penetrate through insulation materials providing sub-mm accuracy. The depth of the pitting is also evaluated in sub-mm resolution using the phase analysis.

Repair systems are applied to restore structural integrity of pipes when defects such as the following occur:
a. External corrosion (Through wall or not through wall)
b. External damage: dents, gouges and fretting
c. Internal corrosion, erosion
d. Crack like defects
e. Strengthening and stiffening in local areas.

A repair system is generally comprised of surface preparation and installation methods used for repair of pipework that can include the use of various substrates, composite materials, filler materials, adhesives and the like.

As shown in FIG. 14, the composite repair system is susceptible to defects such as the following:
f. Interface between repair system and substrate: Delamination (Currently tap test)
g. Surface of repair: cracks, pits, wrinkles, etc. (Visual inspection)
h. Internal laminate defect: Delamination, cracks (Currently tap test)
i. Progression of existing external defects on the substrate.

The mmWave imaging system can pick up these defects in composite wraps applied to oil & gas pipelines.

### Aerospace Maintenance Repair and Overhaul:

As shown in FIG. 15, many aircraft parts are manufactured using lightweight composite materials such as glass fibre reinforced polymer (GFRP). In another embodiment FIG. 15 comprises of 2D image 1502, 3D image 1504, interfacial delamination 1506, void 1508, foreign particle 1510, moisture content 1512.

In one embodiment FIG. 16 comprises of void 1602, rebar mesh 1604, 2D image 1606, 3D image 1608, concrete cover 1610, pillar 1612, beam 1614, rebar corrosion 1616.

A 16-layer honeycomb structure made of GFRP typically used in aircraft parts. Concealed delamination was present across different layers in the structure.

The image scanning system disclosed herein can also be used to detects cracks and corrosion under paint in the metallic parts of the aircraft.

### Reinforced Bar Structures:

FIG. 16 illustrates the system used to test and evaluate the condition of metallic reinforced bar structures (cracks and corrosion in rebar structures) embedded inside concrete pillars and concrete walls. It is also be used to detect internal voids in concrete structures. It can be used to detect the presence/absence of rebars for drilling purpose. The scanner system may also be deployed for determining the concrete cover and the rebar dimensions.

### Spherical Tank Legs:

FIG. 17 illustrates the system used to test and evaluate the condition of legs of spherical tanks under concrete fireproofing to detect corrosion, quantify the area percentage of corrosion and calculate the remaining wall thickness. In another embodiment FIG. 17 comprises of corrosion map under fireproofing 1702, spherical tank 1704, legs with PFP 1706, wire mesh 1708, corrosion 1710, welds 1712, PFP-permanent fire proofing (Concrete cover) 1714.

### Wood and Trees:

Some aspects of infrastructure are made of wood such as wooden ceilings, wooden floors, etc. As the infrastructure ages they undergo the process of rotting or losing integrity due to termite infestation. The image scanning system disclosed herein can be deployed for this application. The scanner system can be deployed for the detection of rotting in tree trunks.

The system can also be used for detecting the quality of wood in rail-road wood ties.

### PE Pipe Inspection:

As shown in FIG. 18, the most common joints of polyethylene (PE) pipes are butt fusion welding and electrofusion welding. In the process of welding, several types of defects can occur. In one embodiment FIG. 18 comprises of cold welds 1802, polymer piping 1804, Butt/electrofusion weld 1806, internal cracks 1808, 3D image of three defects in PE pipe welds 1810, 2D image of three defects in pipe welds 1812.

Typical flaw types in PE joints are Fine particulate contamination (dust), Coarse particulate contamination (sand, grit), Planar flaws (fingerprints, oil and grease, rain droplets), Cold welds and Pipe under penetration in EF joints. The mmWave image scanning system can be deployed to detect these internal volumetric defects.

In another embodiment FIG. 19 comprises of composite wrap 1902, metallic pipe 1904, corrosion 1906, interfacial delamination 1908, internal laminate defect 1910, external defect 1912, internal defect 1914, substrate pipe wall, 1916, composite repair 1918.

The composite repair system is susceptible to defects such as the following: Interface between repair system and substrate, delamination (Currently tap test). Surface of repair, such as cracks, pits, wrinkles, etc. (Visual inspection). The defects may also include internal laminate defects, such as delamination, cracks (Currently tap test), and progression of existing external defects on the substrate. The mmWave scanning system can pick up these defects in composite wraps applied to oil & gas pipelines.

The image scanning system disclosed herein, in conclusion, can be used:
For inspection and detection of cracks in facades, delamination of cladding systems, detection of cracks and corrosion in rebars embedded in structural pillars as well as in floors and ceilings of building and infrastructure;
In oil and gas containers and shipping vessels, which undergo the natural ageing process, to identify the defects such as cracks, corrosion and pittings;
In Aerospace MRO (Maintenance Repair and Overhaul) to detect cracks and corrosion under paint in the metallic parts of the aircraft;
For the detection of rotting in wood and trees and flaws in polyethylene (PE) pipes.

The image scanning system disclosed herein can also be used in different fields, for example for the following:
Biomedical imaging for tumour detection, skin cancer detection, etc;
Surveillance applications to detect concealed weapons;
Automotive radar applications.

Having now described some illustrative embodiments, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method steps or apparatus elements, it should be understood that those steps and those elements may be combined in other ways to accomplish the same objectives. Steps, elements and features discussed only in connection with one embodiment are not intended to be excluded from a similar role in other embodiments.

1. An image scanning system comprising;
a RF subsystem configured with multiple transceiver channels for transmitting and receiving electromagnetic waves in mmWave spectrum;
an interface subsystem;
a signal processing subsystem for producing high resolution holographic images based on backscattered wideband data; and
a software subsystem for 3D/2D visualisation and analysis.

2. The system of claim 1, wherein the RF subsystem comprises a high-performance mmWave front-end with an integrated processor and a hardware accelerator.

3. The system of claim 1, wherein the transceiver channel is an integrated single-chip frequency modulated continuous wave (FMCW) radar sensor.

4. The system of claim 3, wherein the integrated single-chip provides 12 transceiver channels.

5. The system of claim 1, wherein the RF system comprises with four transceiver ICs (Integrated Circuits) with 48 channels in a particular configuration in space such that they are integrated to work together.

6. The system of claim 1, wherein the signal processing subsystem configured to acquire the coordinate information from the localization subsystem residing in modality of deployment of the scanner.

7. The system of claim 1, wherein the signal processing subsystem employs a multiple input multiple output synthetic aperture radar (MIMO SAR) technique to exploit the availability of 24 channels in the scanner system.

8. The system of claim 1, wherein the signal processing subsystem employs the multiple input multiple output synthetic aperture radar (MIMO SAR) technique to exploit the availability of 48 channels in the scanner system.

9. The system of claim 1, wherein the signal processing subsystem utilizes a single input single output (SISO) technique that utilizes one transmit antenna element and one receive antenna element.

10. The system of claim 9, wherein each antenna element operates in a subset of the frequency range of 3 GHz to 300 GHz.

11. The system of claim 1, wherein the signal processing subsystem employs a Digital beamforming (DBF)+SAR technique with 24 channels in the scanner system.

12. The system of claim 1, wherein the signal processing subsystem employs the Digital beamforming (DBF)+SAR technique with 48 channels in the scanner system.

13. The system of claim 1, wherein the signal processing subsystem employs a Chirp-Z-Transform (CZT) based mechanism to focus for 3D imaging.

14. The system of claim 13, wherein raw data obtained from all the channels are in a frequency range between 60 GHz to 81 GHz for the signal processing subsystem.

15. (canceled)

16. The system of claim 1, wherein the system further comprises a localisation subsystem resided either in the system or in the automated platform for inspection.

17. The system of claim 1, wherein the system comprises a modular namely a handheld, a drone mounted, a crawler mounted, a robotic arm mounted or pipe mounted.

18. The system of claim 1, wherein the system further comprises an interface subsystem configured for interfacing various subsystems over various wired and wireless interfaces.

19. The system of claim 1, wherein the software subsystem configured for powerful data visualization, mapping and report generation with AI models running for predictive analysis.

20. A method for obtaining an image of an area under testing using the system of claim 1, the method comprising the steps of:
combining data from RF subsystem and a localisation subsystem by the signal processing subsystem to perform 3D image reconstruction algorithms and data interpretation schemes;
routing the data interpretation and reconstructed 3D image to a software subsystem AI-predictive analysis to visualise the image of area under testing.

21. (canceled)

22. A computer readable storage medium having stored thereon, computer readable instructions, when processed by a processor, cause a system to execute a method for obtaining an image of an area under testing using the system of claim 1, the method comprising the steps of:
combining data from RF subsystem and a localisation subsystem by the signal processing subsystem to perform 3D image reconstruction algorithms and data interpretation schemes;
routing the data interpretation and reconstructed 3D image to a software subsystem AI-predictive analysis to visualise the image of area under testing.
